(19) United States
(12) Patent Application Publication
(10) Pub. No.: US 2025/0007574 A1
(43) Pub. Date: Jan. 2, 2025

(54) RELATIVE ORIENTATION WITH ULTRA-FINE PRECISION

(71) Applicant: Telefonaktiebolaget LM Ericsson (publ), Stockholm (SE)

(72) Inventors: Roland SMITH, Nepean, Ontario (CA); Garry Irvine, OTTAWA, Ontario (CA); Edwin Iun, OTTAWA,Ontario (CA)

(73) Assignee: Telefonaktiebolaget LM Ericsson (publ), Stockholm (SE)

(21) Appl. No.: 18/709,038

(22) PCT Filed: Nov. 30, 2021
(86) PCT No.: PCT/IB2021/061147

§ 371 Date: May 10, 2024

(51) Int. Cl. H04B 7/0456

(52) U.S. Cl. CPC H04B 7/0456

(57) ABSTRACT

A method and network node for determination of relative orientation of a wireless device (WD) with ultra-fine precision are disclosed. According to one aspect, a method in a network node includes determining spatial coordinates of each antenna of a plurality of antennas of the WD. The method also includes determining the relative orientation of the WD based at least in part on the determined spatial coordinates of the plurality of antennas and based at least in part on a model of relative locations of the plurality of antennas of the WD. According to another aspect, a method in a WD includes changing parameters of operation of the WD to disable a determination of relative orientation of the WD by the network node.

### TECHNICAL FIELD

The present disclosure relates to wireless communication and in particular, to determination of relative orientation of a wireless device (WD) with ultra-fine precision.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. Sixth Generation (6G) wireless communication systems are also under development.

In some applications, it may be desirable to determine the orientation of a WD. Estimating the orientation of a rigid body such as a mobile phone is well understood and there are many useful applications to make such an estimation; however, there is no industry consensus on the technology to be applied to 3GPP networks.

In one example, rigid body orientation is determined by an inertial measurement unit (IMU) and an automatic coefficient-tuning complementary filter is used to estimate the 3-D orientation of human body segments. IMU sensors have become common components in smart phones, providing valuable readings from magnetic, gravitational, and inertial sensors in a sensor fixed frame to generate an orientation with respect to an earth-fixed frame.

In another example, a waist mounted device is employed to detect a fall of an elderly person. This application estimates orientation and falling events using inputs from an accelerometer, gyroscope, and magnetometer. This method of detecting orientation has significant value, but requires access to these three sensors, typically requiring specialized software on the waist mounted devices.

Optical analysis has been employed to determine 3-dimensional (3D) orientation. Using this methodology, optical images are augmented with multiple 3D point cloud datasets to teach and enable applications to model 3D objects to further assess their orientation.

Other learning-driven algorithms for local feature detection and subsequent determining of ground-truth orientation is achieved using a convolutional neural network to predict orientations of feature points. Such solutions use high quality images and modeled feature points to estimate orientation.

While orientation has typically been achieved using camera systems and IMU sensors, recent work has been demonstrated using radio frequencies coupled with time of flight (ToF) anchors. A two-dimensional (2D) positioning solution of high accuracy has been employed for navigation, orientation and positioning determinations by service robots using low cost ultra-wideband (UWB) transceivers supporting radio-ranging ToF measurements. This technology achieves centimeter-level accuracy positioning with 100 ms sampling of several fixed anchors with up to 11 anchors in the system.

In short, while many methodologies exist there is no published technology for 3GPP based high precision determination of WD orientation. Existing technology is still very much in the early demonstration stage, without industry consensus on a viable, reliable, and repeatable solution based on commercial off the shelf (COTS) devices. Solutions today are highly optimized university projects with specialized hand-crafted hardware.

The most practical of these solutions requires support from the mobile device, such as providing access to internal sensors. This level of access is most often not possible without user acceptance of sensor access or active downloading and enabling of a specialized application.

In short, there is no current COTS technology to provide orientation of 3GPP devices. While vision systems may be possible, they would demand a comprehensive network to be deployed, which also requires visual access to the device under test (DUT). If the DUT, such as a smart phone is visually obscured, either by a body or by clothing, then visual orientation fails.

### SUMMARY

Some embodiments advantageously provide a method and system for determination of relative orientation of a wireless device (WD), and do so in a manner that provides ultra-fine precision as compared with other arrangements

Some embodiments employ relative positioning coupled with a knowledge of published antenna designs of 3GPP mobile terminals to enable multiple input multiple output (MIMO) operation.

Some embodiments employ a methodology of high precision estimation of relative locations which may have a separation measured in millimeters to centimeters. Some embodiments employ ultra-high precision relative position estimates of a transmission sources, enabling a mobile device to be tracked with high precision (measurement-to-measurement), or for two or more mobile devices to be tracked relative to each other with high precision.

Some embodiments track the relative position of the different WD antennas. It is well known that WDs have many different antennas, some required to support different frequency bands of operation given that antennas have an operational bandwidth typically limited to 12%. Some of these antennas are used for MIMO operation within a band where 4-branch or 8-branch MIMO streams each require a dedicated antenna, and some support non-3GPP wireless applications such as BlueTooth, WiFi, or Near Field sensors. Less well understood in the industry is that antennas used for MIMO operation should be decorrelated, typically achieved by physical separation, but some by cross-polarization. An 8-stream MIMO WD would require at least 4 physical cross-polarized antennas each of which accepts two MIMO feeds, or the WD may have 8 physically separated antennas. Some embodiments, track the relative location of each MIMO antenna with ultra-high precision, which combined with a model of the WD, may be used to establish the relative orientation.

Some embodiments improve upon relative positioning by processing orthogonal reference signals from each of the antenna branches, enabling independent and concurrent detection of each antenna location using time of arrival (ToA) analysis. One example is the uplink (UL) demodulation reference signals (DMRS) which are transmitted by the WD during each transmission time interval (TTI) to enable the radio base station (such as a gNB) to demodulate the different MIMO streams. Other orthogonal reference signals may also be used, such as signals separated in frequency such as through the use of comb filters, or separated in “code” such as using code division multiplexing (CDM) where a single reference symbol is transmitted from each of the MIMO antennas shifted by fractions such as ½, ¼, or ⅛ of a symbol, or separated in time where different MIMO antenna branches transmit reference symbols at different times.

Some embodiments improve relative positioning precision by eliminating WD phase errors which occur between two different WDs or between the same WD in sequential transmissions. When WD-transmitted DMRS reference signals are used by the gNB to estimate relative orientation, these signals are generated from a common WD clock such that instantaneous phase deviations of that common clock are common to each of the transmitted streams.

Some embodiments improve antenna measurements by combining measured antenna signals from different bands transmitted at the same or different times by the WD. Carrier aggregation is a supported feature for 3GPP terminals, and some embodiments described below use the control and measurement capability of the network gNB equipment to make accurate measurements of the different band-specific antennas on a WD. Carrier aggregation is controlled by the gNB and therefore may be employed to cause the WD to transmit data and reference signals on each of the many antennas.

Some embodiments improve the network models of the WD by including many or all of the antennas relative locations to generate a fine resolution fingerprint. Today's WDs support three or more bands each of which typically employ four MIMO antennas. Some embodiments provide measurement of the 3D position of each antenna reference point to provide a detailed “fingerprint” of the WD antennas. This fingerprint may be analyzed using known or learned models of different WDs and using machine learning or other processing means to not only assess the relative orientation of the WD, but also the manufacturer and model number. Such assessments may be probability based, as minute measurement errors in the ultra-fine resolution could indicate slight differences between closely related WD models. Note that an antenna reference point may be, but is not necessarily, in the same physical location as its corresponding antenna.

While some embodiments may be employed to determine relative WD orientation, the fingerprint features of some embodiments may be used to detect the type of user equipment which may not be a mobile phone and may include virtual reality headsets or handsets where radio transceivers may be located.

Some embodiments apply to or implement one or more of the following:
1. A network employed for 3GPP communications, with fixed radio equipment and mobile user equipment devices, receiving a location request;
2. Configuring user equipment to transmit orthogonal reference signals such as DMRS or others including time shifted code division multiplexing (CDM) and Comb or non-Comb multiplexed signals on all antennas of a given band;
3. Extending this configuration to all supported carrier aggregation bands to transmit orthogonal reference signals on active antennas on the user equipment;
4. Receiving a plurality of user equipment band and port specific antenna signals by a plurality of spatially separated antenna reference points of the fixed network equipment;
5. Calculating through correlations, complex conjugates, or other means the time of arrival (ToA) of each of the band and port specific signals transmitted from each WD;
6. Processing a plurality of calculated ToA values to estimate the spatial coordinate locations of each band and port specific WD antenna;
7. Employing models and/or machine learning algorithms to process the spatial coordinates of relative positions to calculate the WD location and orientation; and/or
8. Reporting the WD orientation data in a new NRPPa message to an external application.

Some embodiments may have one or more of the following advantages:
Determining the orientation of any WD with MIMO capabilities without reliance on sensors internal to the WD;
Works with all models and types of WDs;
Network based embodiments ensure consistency of measurements and estimated orientation regardless of the WD model;
Ability determine a model type of the WD; and/or
Augments 3D positioning information about the WD with orientation information providing full 6D positioning.

According to one aspect, a method in a network node for determining a relative orientation of a wireless device includes: determining spatial coordinates of each antenna of a plurality of antennas of the WD; and determining the relative orientation of the WD based at least in part on the determined spatial coordinates of the plurality of antennas and based at least in part on a model of relative locations of the plurality of antennas of the WD.

According to this aspect, in some embodiments, determining the spatial coordinates is based at least in part on processing orthogonal reference signals from different antennas of the plurality of antennas. In some embodiments, the orthogonal reference signals are at least one of uplink demodulation reference signals, DMRS, and sounding reference signals, SRS. In some embodiments, the orthogonal reference signals are at least one of separated in frequency, separated in time, and separated using code division multiplexing, CDM. In some embodiments, each orthogonal reference signal from an antenna port of the plurality of antenna ports includes a reference symbol shifted by a different fraction of a duration of the reference symbol. In some embodiments, determining the spatial coordinates is based at least in part on processing signals having at least one of an auto-correlation and a cross-correlation that is less than a threshold. In some embodiments, the processed signals are received on a physical uplink shared channel, PUSCH. In some embodiments, the processed signals are at least one of separated in frequency, separated in time, separated by code division multiplexing, CDM, and separated orthogonally. In some embodiments, determining the spatial coordinates of each antenna of the plurality of antennas is based at least in part on time of arrival values, the method further comprising: selecting one of the antennas of the plurality of antennas as a reference antenna; and correlating a signal received from the reference antenna with each signal of a plurality of signals from other antennas of the plurality of antennas to produce a time of arrival value for each antenna of the other antennas of the plurality of antennas.

According to another aspect, a network node is configured to determine a relative orientation of a wireless device. The network node includes processing circuitry configured to: determine spatial coordinates of each antenna of a plurality of antennas; and determine the relative orientation of the WD based at least in part on the determined spatial coordinates of the plurality of antennas and based at least in part on a model of relative locations of the plurality of antennas of the WD.

According to this aspect, in some embodiments, determining the spatial coordinates is based at least in part on processing orthogonal reference signals from different antennas of the plurality of antennas. In some embodiments, the orthogonal reference signals are at least one of uplink demodulation reference signals, DMRS and sounding reference signals, SRS signals. In some embodiments, the orthogonal reference signals are at least one of separated in frequency, separated in time, and separated using code division multiplexing, CDM. In some embodiments, each orthogonal reference signal from an antenna of the plurality of antennas includes a reference symbol shifted by a different fraction of a duration of the reference symbol. In some embodiments, the orthogonal reference signals have at least one of an autocorrelation and a cross-correlation that is less than a threshold. In some embodiments, the orthogonal reference signals are received on a physical uplink shared channel, PUSCH. In some embodiments, the orthogonal reference signals are at least one of separated in frequency, separated in time, separated by code division multiplexing, CDM, and separated orthogonally. In some embodiments, determining the spatial coordinates of each antenna of the plurality of antennas is based at least in part on time of arrival values, the processing circuitry being further configured to: select one of the antennas of the plurality of antennas as a reference antenna; and correlate a signal received from the reference antenna with each signal of a plurality of signals from other antennas of the plurality of antennas to produce a time of arrival value for each antenna of the other antennas of the plurality of antennas.

According to yet another aspect, a method in a WD for disabling a determination of one of relative orientation and relative position of the WD is provided. The method includes: causing an error in a determination of spatial coordinates of antennas of the WD by performing at least one of the following: change a mapping between multiple input multiple output, MIMO, streams and antennas of the WD; for each antenna of the WD, apply a different code division multiplex, CDM, time offset to a reference signal transmitted by the antenna of the WD; add inter-symbol clock jitter to a clock signal of the WD; change a phase center of at least one antenna port of the WD; and change a polarization of at least one antenna of the WD.

According to this aspect, in some embodiments, the method also includes changing the mapping between MIMO streams and antennas periodically. In some embodiments, adding CDM offsets between reference signals transmitted by different antennas of the WD includes adding the CDM offsets periodically. In some embodiments, adding inter-symbol clock jitter to a clock signal of the WD includes adding a different amount of jitter to a clock signal of the clock of the WD for each antenna of a plurality of antennas of the WD. In some embodiments, the method further includes causing an error in a determination of spatial coordinates of antennas of the WD by configuring the WD to change transmission time offsets periodically. In some embodiments, the method also includes providing a user interface configured to enable a user of the WD to disable or enable the determination of relative orientation of the WD. In some embodiments, enablement of the determination is the default mode of operation

According to another aspect, a WD is configured to disable a determination of at least one of relative orientation and relative position of the WD. The WD includes processing circuitry configured to: perform at least one of the following: change a mapping between multiple input multiple output, MIMO, streams and antennas of the WD; for each antenna of the WD, apply a different code division multiplex, CDM, time offset to a reference signal transmitted by the antenna of the WD; add inter-symbol clock jitter to a clock signal of the WD; change a phase center of at least one antenna of the WD; and change a polarization of at least one antenna of the WD.

According to this aspect, in some embodiments, the processing circuitry is further configured to change the mapping between MIMO streams and antenna periodically. In some embodiments, adding CDM offsets between reference signals transmitted by different antennas of the WD includes adding the CDM offsets periodically. In some embodiments, adding inter-symbol clock jitter to a clock signal of the WD includes adding a different amount of jitter to a clock signal of the WD for each antenna of a plurality of antennas of the WD. In some embodiments, the processing circuitry is further configured to cause an error in a determination of spatial coordinates of antennas of the WD by configuring the WD to change transmission time offsets periodically. In some embodiments, the WD further includes a user interface configured to enable a user of the WD to disable the determination of relative orientation of the WD.

According to yet another aspect, a WD configured to communicate with a network node includes: at least three non-co-linear antennas being spaced apart by an amount to enable resolution of spatial coordinates of each of the at least three antennas. In other words, the antennas are separated from each other more than the location uncertainty distribution of each antenna caused by measurement error from noise and interference The WD also includes a memory configured to store spatial coordinates for each of the at least three antennas; and a radio interface configured to transmit an indication of the spatial coordinates to the network node. The antennas separation can be 10 centimeters apart for example.

According to another aspect, a method in a WD configured with at least three non-co-linear antennas spaced apart by an amount to enable resolution of spatial coordinates each of the at least three antenna is provided. The method includes: transmitting an indication of spatial coordinates for each of the at least three antennas to a network node. In some example embodiments, the separation of the antennas can be 10 centimeters.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 shows an example of how metal portions of a smart phone can be transparent radio frequencies (RF) to enable transmission of RF signals to and/or from antennas housed within the enclosure of the phone;

FIG. 4 shows examples of relatively complex electrical configurations which may typically be found in some WDs where antennas are embedded in different layers of circuitry components;

FIG. 5 is an example DMRS symbol located within a TTI consisting of 14 symbols, with the second symbol used to send DMRS;

FIG. 6 shows that single or double DMRS symbols may be used with diagonal lines showing that each symbol may contain different DMRS transmissions;

FIG. 7 shows two types of DMRS frequency mapping;

FIG. 8 shows a four port WD in communication with three wireless network ARPs;

FIG. 9 shows correlations for each of the four antenna ports of the WD shown in FIG. 8;

FIG. 10 shows hyperbolic paths used for determining positions of the ARPs of the WD;

FIG. 11 shows pitch, roll and yaw of a WD;

FIG. 12 shows an exchange of messages to facilitate a determination of WD orientation;

FIG. 13 is flowchart of an example process for determining the orientation of a WD;

FIG. 14 is a flowchart of an example process in a network node configured to determine relative orientation of a WD;

FIG. 15 is a flowchart of an example process in a WD to cause an error in a determination of spatial coordinates of antennas of the WD; and

FIG. 16 is a flowchart of an example process in a WD configured with at least three non-co-linear antennas spaced some minimum distance apart.

### DETAILED DESCRIPTION

Before describing in detail example embodiments, it is noted that the embodiments reside primarily in combinations of apparatus components and processing steps related to determination of relative orientation of a wireless device (WD) with ultra-fine precision. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

Some embodiments, provide determination of relative orientation of a wireless device (WD) with ultra-fine precision.

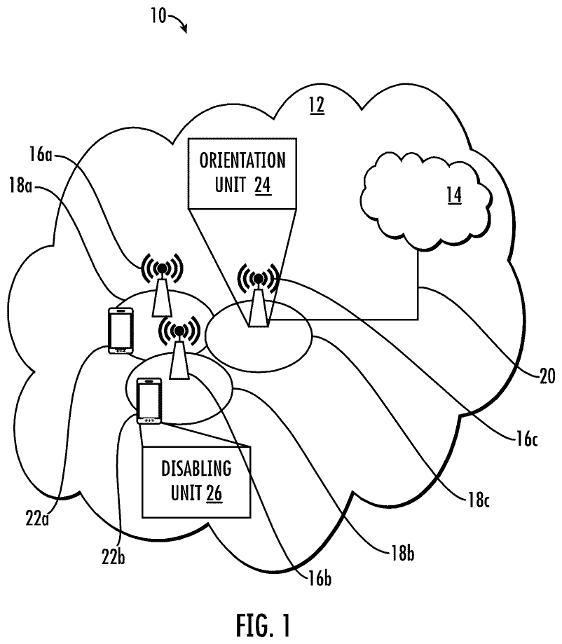

Referring now to the drawing figures, where like reference numerals denote like elements, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

A network node 16 (such as, for example, an eNB or gNB) is configured to include an orientation unit 24 which is configured to determine a relative ultra-high precision orientation of a WD 22. A wireless device 22 is configured to include a disabling unit 26 which may be configured to disable a determination of at least one of relative orientation and relative position of a WD 22. This disabling capability may be turned on or off by a user the WD 22, in some embodiments.

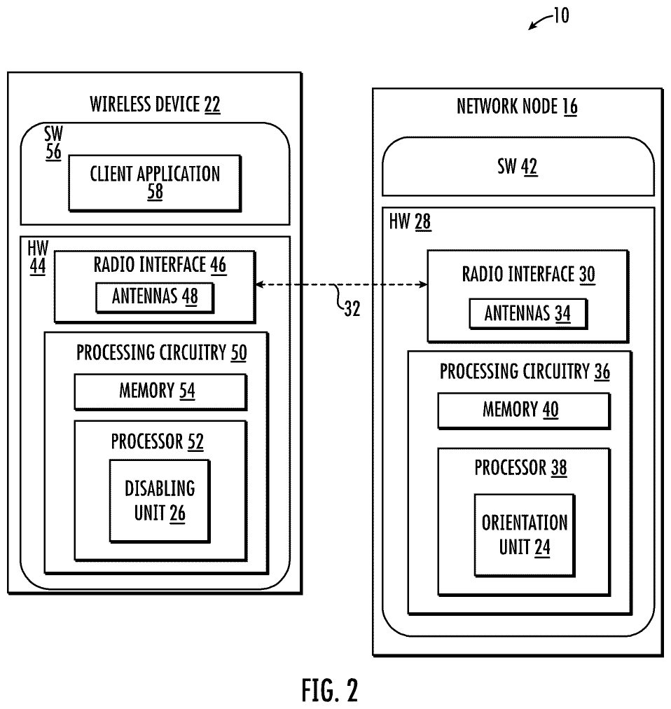

Example implementations, in accordance with an embodiment, of the WD 22 and network node 16 discussed in the preceding paragraphs will now be described with reference to FIG. 2.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include an orientation unit 24 which is configured to determine a relative ultra-high precision orientation of a WD 22.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a disabling unit 26 which may be configured to disable a determination of relative orientation of a WD 22. In some embodiments, the disabling unit 26 may be configurable by the network node to cause disablement of the relative orientation determination. The WD 22 typically includes a user interface (not shown) to enable the user of the WD 22 to control modes of operation of the WD 22, as well as to enable input data and/or voice to the WD 22 and to view and/or hear output from the WD 22. In some embodiments, the user may be able to control whether the WD 22 is configured to disable or enable a determination of at least one of a relative orientation and relative position of the WD 22.

In some embodiments, the inner workings of the network node 16 and WD 22 may be as shown in FIG. 2 and independently, the surrounding network topology may be that of FIG. 1.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units” such as orientation unit 24 and disabling unit 26 as being within a respective processor, it is contemplated that these units may be implemented such that a portion of the unit is stored in a corresponding memory within the processing circuitry. In other words, the units may be implemented in hardware or in a combination of hardware and software within the processing circuitry.

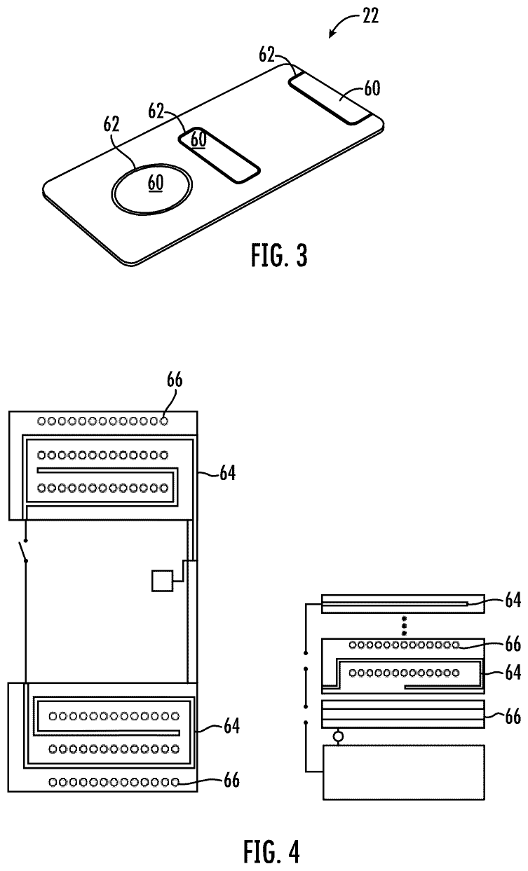

FIG. 3 shows an example of how metal portions of a smart phone can be transparent radio frequencies (RF) to enable transmission of RF signals to and/or from antennas housed within the enclosure of the phone. Transparent regions can be referred to as RF windows, segments, or lines. RF transparent materials can be non-conductive materials such as glass, plastic or ceramic. FIG. 3 also shows electrically isolated regions 60 which may serve as antenna locations. In addition, metal oxide portions 62 may encompass the regions 60 and can be electrically non-conductive and RF transparent and can serve as RF windows or RF transparent segments/lines.

To support increasing numbers of bands, designs enable more locations on the metallic and/or glass body of a WD 22 to be used for physically separated antennas, highlighted by the most recent whole glass/ceramic body WDs. These latest devices empower designers to hide antennas behind a colored ceramic body, while enabling sufficient separation of the antennas to guarantee independent MIMO streams.

There are known solutions to embed antennas inside mobile user equipment. For example, FIG. 4 shows examples of relatively complex electrical configurations which may typically be found in some WDs where antennas 64 are embedded in different layers of circuitry components 66. However, antennas require physical space so that they are not all co-located and may be separated a half of a wavelength (λ/2) or more to maximize isolation and reduce mutual coupling, since MIMO systems often require sufficient isolation such as 20 dB.

Some embodiments described herein utilize this physical separation and non-collocation to determine orientation of the WD 22. Note that the electrical separation of the antennas is different for different frequency bands so that orientation determinations may be made based on measurements in the different frequency bands.

Various reference signals may be used for ToA calculations, which are in turn used to determine relative orientation of the WD 22. One reference signal that may be employed for ToA measurements is the demodulation reference signal. The DMRS in the UL is used by network equipment for radio channel estimations. DMRS transmitted every TTI enable UL MIMO operation, with a variable number of symbols allocated to address issues such as doppler shift. DMRS can be transmitted in the downlink (DL) by the gNB radio to enable user equipment to perform channel estimation. MIMO DMRS transmissions are sent one per antenna port using one of several orthogonal processes.

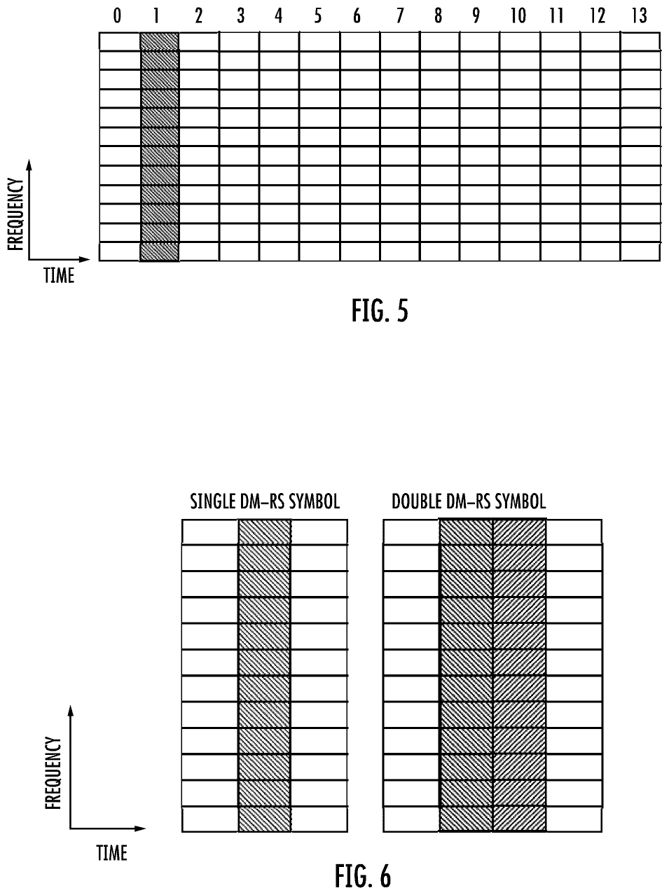

FIG. 5 is a chart of an example DMRS symbol located within a TTI consisting of 14 symbols, with the second symbol used to send DMRS. FIG. 6 shows that single or double DMRS symbols may be used with diagonal lines showing that each symbol may contain different DMRS transmissions.

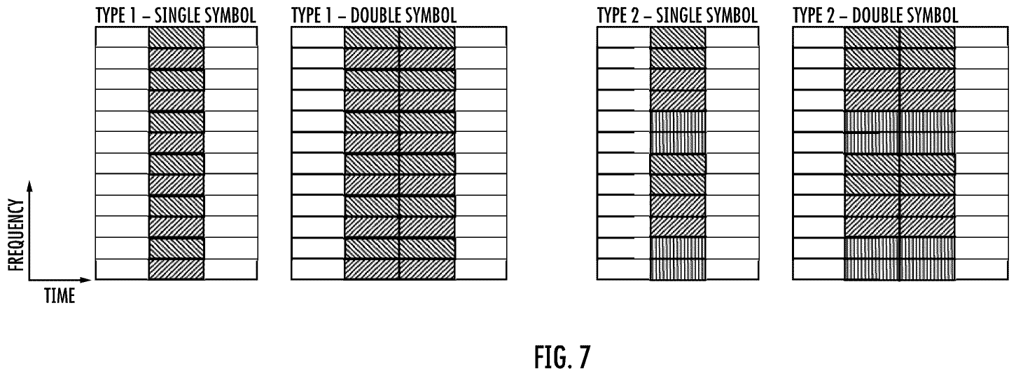

Furthermore, there are two types of DMRS frequency mapping: Type 1 which is Comb based with 2 CDM groups and Type 2 which is non-comb based with 3 CDM groups which are shown in FIG. 7. Type 1 comb-based map DMRS onto alternating comb frequencies applicable to both single and double symbols. Type 2 non-comb-based maps DMRS onto alternating frequency blocks allowing for different CDM groups.

These two DMRS types enable scaling of the number of supported layers with 2 ports/CDM group for single symbols and 4 ports/CDM group for double symbols.

Thus, discernable orthogonal DMRS codes that scale with the number of transmitted layers enable support for up to 12-layers of transmission with a unique DMRS port per layer. Since the DMRS is port based, it may be used for independent ToA processing of each antenna port on a user equipment.

Orthogonality in frequency and/or CDM enables ToA functions to be based on knowledge of the DMRS by matching the received signal to a stored time or frequency copy of the sequence to derive a ToA estimate of a CDM signal, or alternately to employ functions correlating over the air (OTA) data received at different antenna reference points without knowledge of the data content. While a matched filter may be employed for separation of CDM signals, the second method is a correlation function without any knowledge of the input data. While a matched filter may achieve better results in some embodiments which employ CDM signals, the correlation operation has an advantage of not requiring knowledge of the content signals being correlated.

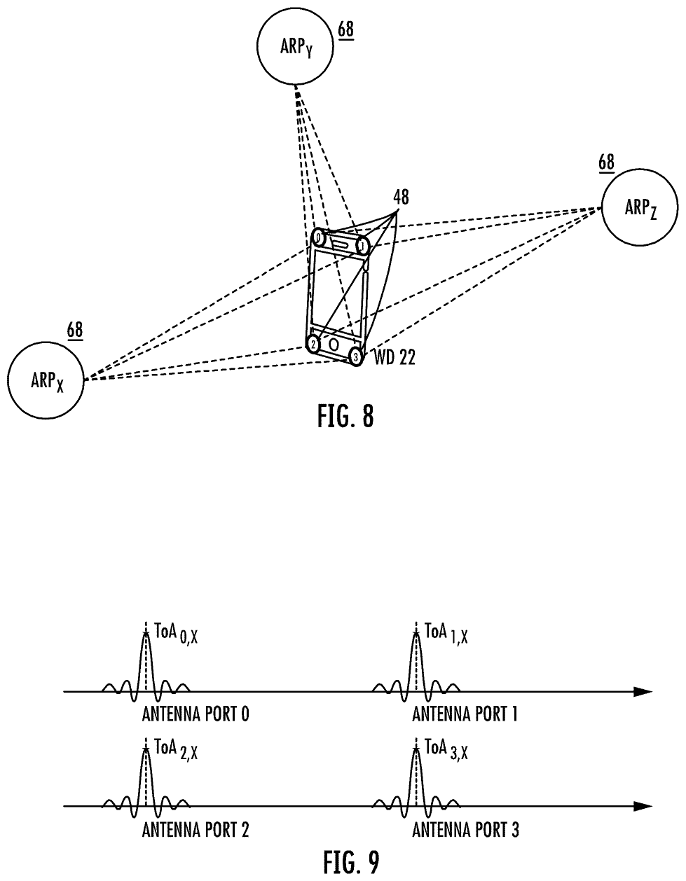

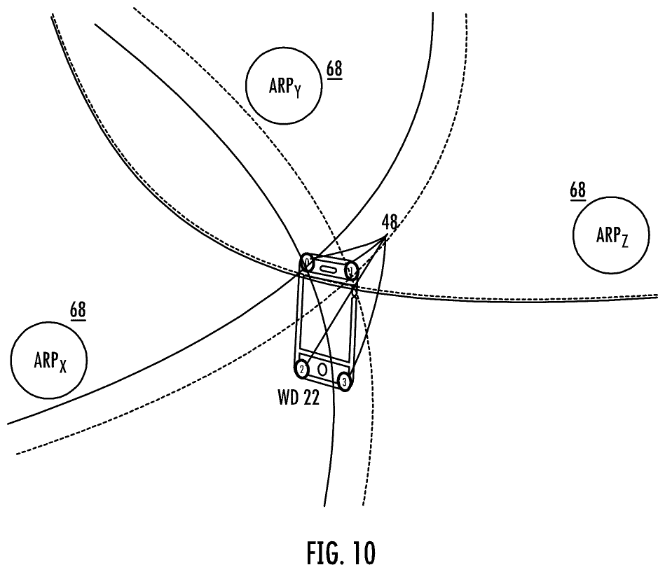

DMRS may be used to measure ToA with a 4-port WD 22 shown in FIG. 8 with antennas 48 located in the corners for the purpose of the following explanation. Assume a Type 1 configuration with a single symbol and two CDM groups. Here, ports 0 and 1 are mapped to one comb and ports 2 and 3 are mapped to a second comb, where combs are separated in time by ½ of a symbol so that the resulting correlations against the known DMRS patterns result in four ToA measurements: ToA₀, ToA₁, ToA₂, and ToA₃ as seen by a wireless network antenna reference point ARP_{X} 68 with similar ToA measurements seen at ARP_{Y} 68 and ARP_{Z} 68. The resulting ToA correlations measured at ARP_{X} 68 are shown in FIG. 9, there being one correlation shown for each of the four antennas of the WD 22. Note that each wireless network antenna reference point 68 corresponds to an antenna of at least one network node 16. Similarly, there is a WD ARP corresponding to each antenna of the WD.

While these four signals appear quite similar, at each ARP, after adjusting the ½ symbol offset for each of the four ports, and using fine interpolation, there is a small but detectable difference in the measured ToA value from each antenna port to the ARP. A time difference between the measured ToA from each of the four antenna ports may have a resolution sufficient to uniquely identify the relative position of the antennas. A relative resolution of 15 picoseconds (ps) would give 5 millimeter (mm) precision on these antenna ports, quite achievable with a 100 MHz carrier bandwidth and a good signal to noise ratio (SNR) of at least 10 dB for example.

The above method assumed knowledge of the DMRS pattern, resulting in four separate ToA calculations with respect to that pattern, which is over determined for 3D orientation estimation.

If the DMRS pattern is not known, then one of the antenna ports may be selected as a reference and used for cross correlations against the remaining ports yielding three independent ToA measurements, sufficient for 3D orientation determination.

The example above is provided for the DMRS, but is also applicable to other signals which are port specific, including the phase tracking reference signal (PTRS), sounding reference signal (SRS), and channel state information reference signal (CSI-RS). Many of these signals enable independent measurements to be made on each of the WD antenna ports to enable ultra-fine precision relative positioning measurements.

Note that ultra-fine ToA measurements may be made using Type 1 Comb based DMRS with a single or double symbol, rather than symbols which are further separated in time, such as in the case of front loaded DMRS with additional DMRS more typically used to mitigate doppler effects. There may be an impact of WD crystal phase noise on measurement coherence when separated by many symbols.

Positioning accuracy depends on time of arrival (ToA) accuracy, rTE accuracy, ARP coordinate accuracy and spatial geometry. ToA accuracy is a function of at least the signal bandwidth, signal to noise ratio and channel multipath effects. The rTE is a function of clock phase alignment, which is limited by wander and jitter, and the ability to precisely measure component delays such as band pass filter variations in different ARPs. The ARP (x, y, z) coordinates also have an accuracy which may be on the order of millimeters, centimeters or larger errors in the coordinates of the ARPs recorded by installers versus their actual positions. Spatial geometry can impact positioning accuracy through dilution of precision for non-ideal geometries (such as co-linear ARP locations) whereby small measurement errors result in larger positional accuracy errors. This is the case where intersecting hyperbolic solution curves are nearly parallel, resulting in uncertainty along the path of intersection. Ideal spatial geometries would have ToA solution curves intersecting with high orthogonality such as angles approaching 90 degrees.

Relative positioning assumes many of these parameters are unchanging between ToA measurements, such as signal bandwidth, SNR, ARP coordinates, and ARP spatial geometry, and some of the rTE parameters such as signal filter delays. The remaining contributions to errors include ToA jitter and wander, as well as multipath effects. Ultra-fine positioning minimizes the impact these remaining errors have on calculated ToA.

Clock jitter and wander is eliminated by only processing ToA data from the same symbol, whereas relative positioning may compare sequential positioning estimates sent every 100 ms. While clock jitter and wander is known to be minimal (such as +/−50 picoseconds over a period of many seconds), ultra-fine positioning sees no clock jitter in comparing ToA values calculated from the same symbol.

Similarly, multipath effects are an environmental factor affecting ToA accuracy. Multipath effects result in a superposition of signals reflected from many different directions between the transmitter and ToA receiver and is a function of WD 22 location in combination with the phased summation (addition or cancellation) of the signal over the full range of signal bandwidth.

Ultra-fine positioning performed on a single symbol eliminates environmental changes as the WD 22 is unable to change physical location during the 33 microseconds duration of a single symbol, while relative positioning allows for small changes in position (and therefore environmental multipath) as the WD 22 moves over longer periods of time.

Also, ultra-fine positioning ensures that frequency dependent aspects of environmental multipath effects remain constant by correlating different ToA values which use frequency interleaving (via comb filters) so that their multipaths are “nearly” the same, or by calculating different ToA signals which are code multiplexed (CDM or other) across the same frequency resources. For code division multiplexing, the multipath effects are identical to each of the calculated ToA values.

Ultra-fine positioning as that term is used herein is therefore similar to relative positioning but may be targeted to WD relative orientation where ToA measurements can be made of the various WD antenna ports (or physical antennas) under the above-described conditions which eliminate all known sources of relative errors impacting accuracy.

ToA measurements may have significant absolute errors such as a (x, y, z) coordinate of one of the ARPs may be off by 70 centimeters (cm). However, the relative ToA measurements of different WD antennas made through the method of ultra-fine positioning will have nearly zero relative errors. It is therefore expected that ultra-fine positioning may achieve accuracy to determine orientation of small WDs 22 such as smart phones where antennas (or antenna ports) may be located quite close to each other.

Thus, ultra-fine positioning as disclosed herein enables resolution between different antenna ports on a WD, such as a hand held smart phone. In some embodiments, a two-step algorithm for estimating the 3D orientation is provided.

### First Step-3D Ultra-Fine Positioning

The antenna port ToA values measured at each ARP may be used to estimate the 3D coordinates of the antennas. Many different algorithms are available to perform this function most often assuming time difference of arrival (TDoA) rather than ToA measurements. TDoA measurements consider only the difference in ToA of the signals rather than an absolute time. TDoA is used where absolute over the air (OTA) time is unknown or cannot be measured. TDoA provides a means to estimate the 3D coordinates using intersecting hyperbolic curves representing constant time difference.

This is shown in 2D in the example of FIG. 10, where ToA₀ or more specifically TDoA₀ measurements made at ARP_{X}, ARP_{Y}, and ARP_{Z} are used to determine hyperbolic paths showing constant differential distances. In FIG. 10, WD Antenna Port 0 is found at the intersection of three hyperbolic paths indicated with solid lines, and WD Antenna Port 1 is found at the intersection of three hyperbolic paths indicated with dashed lines. This first step can be achieved in many ways and is considered common knowledge to those skilled in the art.

The outcomes of this first step is to determine the spatial coordinates (xi, yi, zi) of the WD's antennas. In FIG. 10, assuming additional ARPs are available to enable proper 3D estimations, then the end result will be coordinates: {(x0, y0, z0), (x1, y1, z1), (x2, y2, z2), (x3, y3, z3)}. This set of four points—one for each of the antenna ports employed for a specific band, may be repeated to estimate additional coordinates of the antennas used for other bands.

As previously stated, WDs today support many bands which operate concurrently, as is the case of combined carriers used to increase throughput. In these more typical multicarrier cases, the outcome of the first step may have 4, 8, 12 or more 3D band-specific antenna coordinates enabling a significantly determined solution necessary to address issues of multipath, shadowing, and noise.

### Second Step—Ultra-Fine Orientation

Once the set of ultra-fine relative coordinates have been determined, known algorithms may be employed to estimate the WD 22 orientation. A common frame of reference may be desired for any estimated orientations for which there is known documentation.

UE orientation can be expressed in relative terms as pitch, role and yaw indicating the three rotations applied to arrive at a unique orientation as shown in s. Other orientation systems may be employed depending on the application such as the device to be tracked. Rigid body orientation can be defined as a fixed frame attached to the body relative to a localized reference system. For example, a factory workspace may define a localized reference system for welding work at a specific station. In this case, the orientation system using body-axes rotation with successive rotations of each independent axis determines the body's fixed reference frame. In such a case, a set of three angles Θ, φ, and ψ are sufficient.

Some embodiments use ultra-fine precision measurements of DMRS or other antenna port specific transmissions to estimate antenna port coordinates and therefore the orientation of the user equipment. Measurements can be made on all antenna ports for a specific band, as well as across all bands involved in carrier aggregation resulting in an overdetermined set of measurement points.

Note there are many WD 22 models many of which have unique band support and physical antenna locations. Positioning technologies have long since employed fingerprint databases of cities to aid in mapping measurement data yielding improved accuracy. In a similar way, some embodiments provide for fingerprint databases of WD 22 models containing stored relative antenna locations. These WD 22 fingerprints may be represented as datasets of measurements or may be distilled into formal models of relative antenna locations for each WD 22 model.

Specific WD 22 models may have a fingerprint or device or antenna model and have parameters such as supported bands in a region or by carrier to clearly detail possible antenna configurations. These fingerprint models may be made across multiple devices of a given type to include parameter variability such as the stability of the local oscillator or even filter delay variations. Machine learning may be employed to generate and refine these models, which would then be leverage in products deployed in the field, allowing new WD 22 models to be added to the database as they are introduced.

Some embodiments include methods for disabling a determination of relative orientation and/or relative position of a WD 22, such as by a user. At least some of these methods achieve tracking disablement whether the determination sought is based on one or more of relative position tracking, relative orientation tracking and time of arrival-based tracking. Such methods may include one or more of the following:
1. Switching MIMO streams from one antenna port to another antenna port.

For example, consider a WD 22 with 4-ports in defined physical locations. The disabling of relative orientation determination includes switching MIMO streams between ports causing “port swapping” to occur. A deliberate switch of antenna ports 0←→1, 2←→3, when processed using known DMRS sequences, would appear as a 180° rotation in the role of the WD 22, so that the screen is facing away from the user. Similarly, a switch of antenna ports 0←→2, 1←→3 processed using known DMRS sequences would appear as a 180° rotation in the pitch of the WD 22, making the WD 22 appear as if the phone is upside down.
2. Changing CDM time delays.

While the 3GPP standard is quite specific on the allowed CDM time offsets, specifically requiring a λ/2 offset, dynamically changing this offset impacts the calculated relative coordinates of the antenna ports. For example, if ports 0 and 1 have a CDM separation of λ/2, and the calculated TDoA difference between the two ports is λ/2+180 ps, then the distance between the two antenna ports would be calculated as:

$$Distance = c \times t = 3 \cdot {10}^{8} m / s \times 180 \cdot {10}^{- 12} s = 5.4 cm$$

However, in some embodiments, the WD 22 dynamically shifts the CDM time offset, for example by ±180 ps between consecutive transmissions, so that the calculated distance D may alternate between 0 and 10.8 cm. Thus, in some embodiments, the WD 22 dynamically shifts the CDM time delay, frame by frame.
3. Introducing Inter-Symbol Clock Jitter and/or Inter-Symbol Signal Jitter.

The 3GPP standard is designed to enable a WD 22 to employ a common clock to transmit the consecutive symbols (typically 14 symbols) in a TTI (transmission time interval) to minimize phase jitter between symbols. This does not eliminate phase jitter since the clocks used in WDs will have a low inherent jitter to meet the ±50 ppb (parts per billion) timing specification, which translates into a maximum clock drift of ±50 nanoseconds per second (ns/s). This drift becomes small over the time period of a TTI (1 ms for LTE or 0.5 ms for NR) for a drift of 25 ps for NR to 50 ps for LTE. As mentioned in this disclosure, ultra-fine precision is best achieved when measuring ToA across a single or a double symbol, further reducing the clock drift from (25 ps, 50 ps) for (NR, LTE) by a factor of 14 for a single symbol or 7 for a double symbol. Based on this, LTE/NR (single, double) symbols would see maximum clock drifts of (4 ps, 8 ps), respectively.

Accordingly, in some embodiments, the WD 22 is configured to statically or dynamically adjust inter-symbol jitter either from the source clock used to generate the symbols, or in the source data transmitted at the antenna.
4. Antenna Phase Center and/or Polarization Manipulation.

Antennas employed today in WDs are either fixed or switched elements with static and deterministic patterns. Fixed antennas may be radiating elements which are embedded at fixed locations in a WD 22. Switched antennas may also be radiating elements where the switching function is used to modify antenna parameters such as the operational band.

In the case of switched antennas, the switching function is static after the band selection has been established and therefore does not change during operation. Also, changing the switching elements controlling an antenna changes the size of the element and the resulting phase center and can also alter the polarization. Any changes to the phase center or polarization of the antenna will impact the measured relative ToA or TDoA. In the case of a phase center change, the relative position of the antenna will shift with the phase center. In the case of a polarization change, the relative multipath components of the transmissions from that antenna will change, resulting in an apparent change in the relative position of the antenna.

Further, any switching that occurs while transmitting antenna signals may result in a transient glitch in the transmitted and/or received signal due to impedance changes. This transient is often magnified by radio front end filters resulting in signal distortions which may last 10 s of nanoseconds. For this reason, WD 22 manufacturers may limit antenna configuration changes to call setup, and never make changes during operation. In contrast, in some embodiments disclosed herein, dynamic switching of antenna elements during normal operation is caused to occur between TTIs or during inter-symbol guard periods, or when the transmitter and receiver are not in operation, resulting in a change of the phase center and/or polarization of the antenna.
5. Changing transmission time offsets.

The WD 22 may be configured to change transmission time offsets periodically or occasionally by hundreds of nanoseconds (i.e., multiple clock cycles) to prevent a network node 16 from accurately determining relative orientation or relative position of the WD 22.

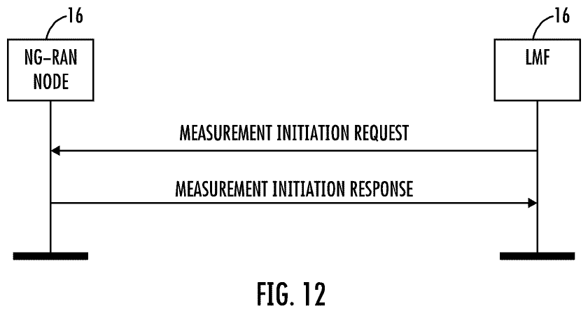

Some embodiments may employ messages for 3GPP and industry standards that are exchanged as shown in the example of FIG. 12. The 3GPP specification NR Positioning Protocol A (NRPPa) defines a set of elementary messaging protocols between the NG-RAN Node which may be a first network node 16 and the location management function (LMF) which may be located at a second network node 16. Elementary messages are focused on existing features such as E-CID and OTDOA, both of which employ “measurement initiation request” and “measurement initiation response” to obtain WD 22 positioning information.

While NRPPa defines many parameters which the NG-RAN Node may report, some embodiments disclosed herein provide parameters in the NRPPa message defining the WD 22 orientation with an optional reference plane.

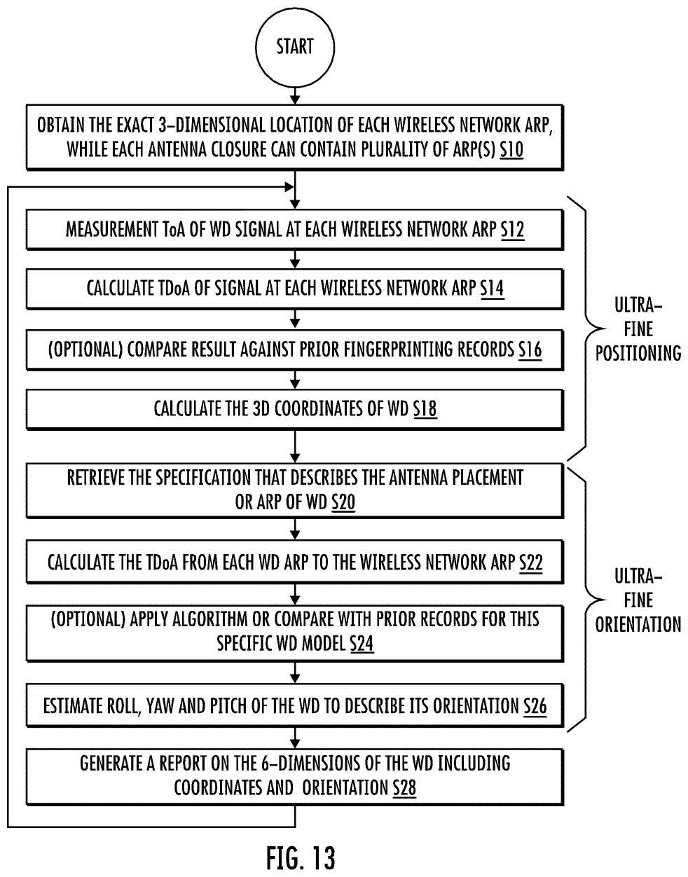

FIG. 13 is flowchart of an example process for determining the orientation of a WD 22. The process may be performed by a network node 16, including processing circuitry 36, processor 38 and orientation unit 24. The process includes determining a 3D location of each wireless network antenna reference point (ARP), where each antenna enclosure may contain a plurality of ARPs. An advantage of having multiple ARPs is the attainment of antenna diversity to overcome multipath effects by selecting one or more antennas having a high or highest cross-correlation peak. In Blocks S12-S18, ultra-fine position of the WD 22 is determined. This subprocess includes measuring times of arrival of WD signals at each wireless network ARP (Block S12). The process also includes calculating time differences of arrival of signals at each wireless network ARP (Block S14). Optionally, a result of the calculations are compared to fingerprint records of WDs 22 (Block S16). The process includes calculating the 3D coordinates of the WD 22 (Block S18).

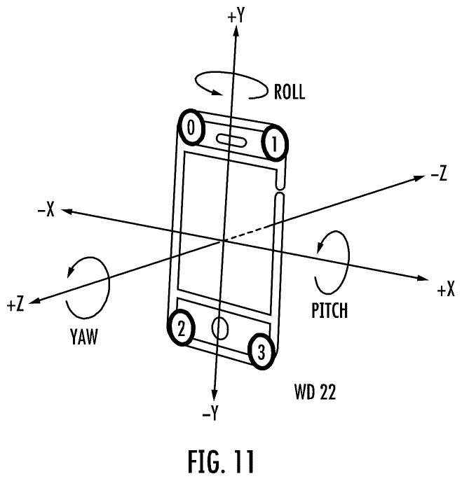

In Blocks S20-S26, ultra-fine orientation of the WD 22 is determined. This subprocess includes retrieving information that describes or indicates an antenna placement or ARPs of the WD 22 (Block S20). Based in part on the retrieved information, time differences of arrival are calculated for signals from each of a plurality of ARPs of the WD 22 to a wireless network ARP (Block S22). Optionally, an algorithm or compare with prior records for the model of the WD 22 to determine an orientation of the ARPs of the WD 22 (Block S24). The subprocess for ultra-fine determination of WD 22 orientation shown in FIG. 13 includes estimating the roll, yaw and pitch, as shown in FIG. 11, of the WD to describe its orientation with respect to the earth, a user, a mobile platform or stable reference plane (Block S26).

The process includes generating a report of the 6D coordinates that include absolute coordinates of the WD 22 and orientation with respect to those absolute coordinates (Block S28). Absolute coordinates may refer to coordinates in a stable reference system, or coordinates relative to the earth, or coordinates relative to a mobile platform.

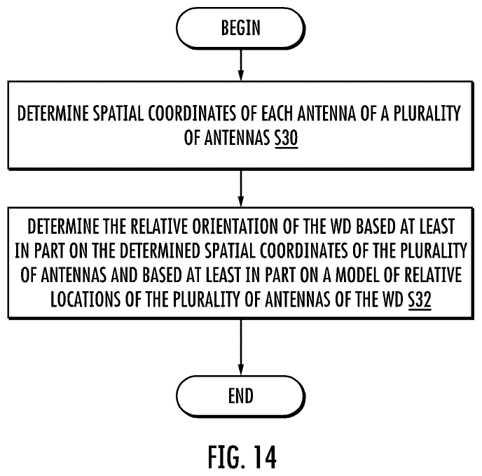

FIG. 14 is a flowchart of an example process in a network node 16 configured to determine relative orientation of a WD 22. The process may be performed by a network node 16, including processing circuitry 36, processor 38 and orientation unit 24. The process includes determining spatial coordinates of each antenna 48 of a plurality of antennas 48 of the WD 22 (Block S30). The process also includes determining the relative orientation of the WD 22 based at least in part on the determined spatial coordinates of the plurality of antennas 48 and based at least in part on a model of relative locations of the plurality of antennas 48 of the WD 22 (Block S32).

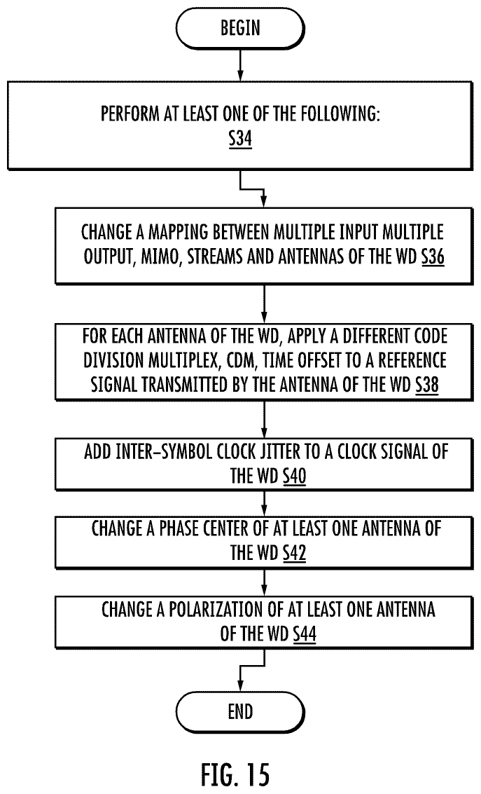

FIG. 15 is a flowchart of an example process in a WD 22 configured to cause an error in a determination of spatial coordinates of antennas 48 of the WD 22. The process may be performed by a WD 22, including processing circuitry 50, processor 52 and disabling unit 26. The process includes performing at least one of the following (Block S34): change a mapping between multiple input multiple output, MIMO, streams and antennas of the WD (Block S36); for each antenna 48 of the WD 22, apply a different code division multiplex, CDM, time offset to a reference signal transmitted by the antenna 48 of the WD 22 (Block S38); add inter-symbol clock jitter to a clock signal of the WD 22 (Block S40); change a phase center of at least one antenna port of the WD 22 (Block S42); and change a polarization of at least one antenna 48 of the WD 22 (Block S44).

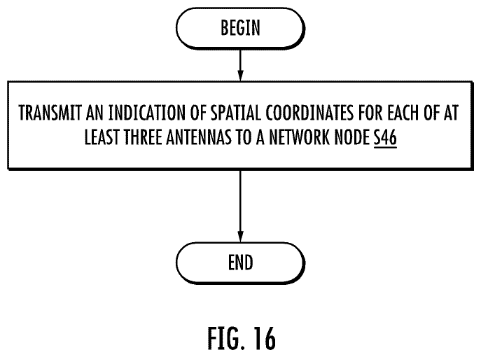

FIG. 16 is a flowchart of an example process in a WD 22 configured with at least three non-co-linear antennas spaced at least 10 centimeters apart. The process may be performed by processing circuitry 50, processor 52 and radio interface 46. The process includes: transmitting an indication of spatial coordinates for each of the at least three antennas to a network node (Block S46).

According to one aspect, a method in a network node 16 for determining a relative orientation of a wireless device 22 includes: determining spatial coordinates of each antenna 48 of a plurality of antennas 48 of the WD 22; and determining the relative orientation of the WD 22 based at least in part on the determined spatial coordinates of the plurality of antennas 48 and based at least in part on a model of relative locations of the plurality of antennas 48 of the WD 22.

According to this aspect, in some embodiments, determining the spatial coordinates is based at least in part on processing orthogonal reference signals from different antennas 48 of the plurality of antennas 48. In some embodiments, the orthogonal reference signals are at least one of uplink demodulation reference signals, DMRS, and sounding reference signals, SRS. In some embodiments, the orthogonal reference signals are at least one of separated in frequency, separated in time, and separated using code division multiplexing, CDM. In some embodiments, each orthogonal reference signal from an antenna port of the plurality of antenna ports includes a reference symbol shifted by a different fraction of a duration of the reference symbol. In some embodiments, determining the spatial coordinates is based at least in part on processing signals having at least one of an auto-correlation and a cross-correlation that is less than a threshold. In some embodiments, the processed signals are received on a physical uplink shared channel, PUSCH. In some embodiments, the processed signals are at least one of separated in frequency, separated in time, separated by code division multiplexing, CDM, and separated orthogonally. In some embodiments, determining the spatial coordinates of each antenna 48 of the plurality of antennas 48 is based at least in part on time of arrival values, the method further comprising: selecting one of the antennas 48 of the plurality of antennas 48 as a reference antenna 48; and correlating a signal received from the reference antenna 48 with each signal of a plurality of signals from other antennas 48 of the plurality of antennas 48 to produce a time of arrival value for each antenna 48 of the other antennas 48 of the plurality of antennas 48.

According to another aspect, a network node 16 is configured to determine a relative orientation of a wireless device. The network node 16 includes processing circuitry 36 configured to: determine spatial coordinates of each antenna 48 of a plurality of antennas 48; and determine the relative orientation of the WD 22 based at least in part on the determined spatial coordinates of the plurality of antennas 48 and based at least in part on a model of relative locations of the plurality of antennas 48 of the WD 22.

According to this aspect, in some embodiments, determining the spatial coordinates is based at least in part on processing orthogonal reference signals from different antennas 48 of the plurality of antennas 48. In some embodiments, the orthogonal reference signals are at least one of uplink demodulation reference signals, DMRS and sounding reference signals, SRS signals. In some embodiments, the orthogonal reference signals are at least one of separated in frequency, separated in time, and separated using code division multiplexing, CDM. In some embodiments, each orthogonal reference signal from an antenna 48 of the plurality of antennas 48 includes a reference symbol shifted by a different fraction of a duration of the reference symbol. In some embodiments, the orthogonal reference signals have at least one of an autocorrelation and a cross-correlation that is less than a threshold. In some embodiments, the orthogonal reference signals are received on a physical uplink shared channel, PUSCH. In some embodiments, the orthogonal reference signals are at least one of separated in frequency, separated in time, separated by code division multiplexing, CDM, and separated orthogonally. In some embodiments, determining the spatial coordinates of each antenna 48 of the plurality of antennas 48 is based at least in part on time of arrival values, the processing circuitry 36 being further configured to: select one of the antennas 48 of the plurality of antennas 48 as a reference antenna 48; and correlate a signal received from the reference antenna 48 with each signal of a plurality of signals from other antennas 48 of the plurality of antennas 48 to produce a time of arrival value for each antenna 48 of the other antennas 48 of the plurality of antennas 48.

According to yet another aspect, a method in a WD 22 for disabling a determination of at least one of relative orientation and relative position of the WD 22 is provided. The method includes: causing an error in a determination of spatial coordinates of antennas 48 of the WD 22 by configuring the WD 22 to perform at least one of the following: change a mapping between multiple input multiple output, MIMO, streams and antennas 48 of the WD 22; for each antenna 48 of the WD 22, apply a different code division multiplex, CDM, time offset to a reference signal transmitted by the antenna 48 of the WD 22; add inter-symbol clock jitter to a clock signal of the WD 22; change a phase center of at least one antenna port of the WD 22; and change a polarization of at least one antenna 48 of the WD 22.

According to this aspect, in some embodiments, the method also includes changing the mapping between MIMO streams and antennas 48 periodically. In some embodiments, adding CDM offsets between reference signals transmitted by different antennas 48 of the WD 22 includes adding the CDM offsets periodically. In some embodiments, adding inter-symbol clock jitter to a clock signal of the WD 22 includes adding a different amount of jitter to a clock signal of the clock of the WD 22 for each antenna 48 of a plurality of antennas 48 of the WD 22. In some embodiments, the method further includes causing an error in a determination of spatial coordinates of antennas of the WD 22 by configuring the WD 22 to change transmission time offsets periodically. In some embodiments, the method also includes providing a user interface configured to enable a user of the WD 22 to disable the determination of relative orientation of the WD 22.

According to another aspect, a WD 22 is configured to disable a determination of at least one of relative orientation of the WD 22. The WD 22 includes processing circuitry 50 configured to: perform at least one of the following: change a mapping between multiple input multiple output, MIMO, streams and antennas 48 of the WD 22; for each antenna 48 of the WD 22, apply a different code division multiplex, CDM, time offset to a reference signal transmitted by the antenna 48 of the WD 22; add inter-symbol clock jitter to a clock signal of the WD 22; change a phase center of at least one antenna 48 of the WD 22; and change a polarization of at least one antenna 48 of the WD 22.

According to this aspect, in some embodiments, the processing circuitry 50 is further configured to change the mapping between MIMO streams and antenna 48 periodically. In some embodiments, adding CDM offsets between reference signals transmitted by different antennas 48 of the WD 22 includes adding the CDM offsets periodically. In some embodiments, adding inter-symbol clock jitter to a clock signal of the WD 22 includes adding a different amount of jitter to a clock signal of the WD 22 for each antenna 48 of a plurality of antennas 48 of the WD 22. In some embodiments, the processing circuitry 50 is further configured to cause an error in a determination of spatial coordinates of antennas 48 of the WD 22 by configuring the WD 22 to change transmission time offsets periodically. In some embodiments, the WD 22 further includes a user interface configured to enable a user of the WD 22 to disable the determination of relative orientation of the WD 22.

According to yet another aspect, a WD configured to communicate with a network node includes: at least three non-co-linear antennas being spaced apart by an amount to enable resolution of spatial coordinates of each of the at least three antennas. In other words, the antennas are separated from each other more than the location uncertainty distribution of each antenna caused by measurement error from noise and interference The WD also includes a memory configured to store spatial coordinates for each of the at least three antennas; and a radio interface configured to transmit an indication of the spatial coordinates to the network node. In some example embodiments, the separation of the antennas can be 10 centimeters.

According to another aspect, a method in a WD configured with at least three non-co-linear antennas spaced apart by an amount to enable resolution of spatial coordinates each of the at least three antenna is provided. The method includes: transmitting an indication of spatial coordinates for each of the at least three antennas to a network node. The antennas separation can be 10 centimeters apart for example.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Some abbreviations that may be used herein are explained as follows:
3GPP 3rd Generation Partnership Project responsible for mobile telecommunications standards development.
4G Fourth Generation (LTE) Radio
5G Fifth Generation (NR) Radio
AECID Advanced Enhanced Cell Identifier
ARP Antenna Reference Point
BAW Bulk Acoustic Wave—a filter used in radios
BF Beamforming
CAPEX Capital Expenditures
COTS Commercial Off The Shelf
DL Downlink
Dot Digital remote radio used in Ericsson's Radio Dot System
DU Digital Unit
E911 Emergency 911 service for cell phone users.
eNB Enhanced Node B
GPS Global Positioning System
IEEE 1588 Institute of Electrical and Electronic Engineers, Standard #1588
IRU Indoor Radio Unit
KPI Key Performance Index
LTE Long Term Evolution (4th Generation Cellular)
LBT Listen Before Talk
LTE Long Term Evolution
NR Next Generation Radio
OPEX Operational Expenditures
OTDoA Observed Time Difference of Arrival
PLL Phase-Locked-Loop
PTP Precision Time Protocol (from IEEE 1588)
RDS Radio Dot System
RIBM Radio Interface Based Monitoring
RSRP Reference Signal Received Power
RSSI Received Signal Strength Indication
rTE Relative Time Error
RTT Round Trip Time
SAW Surface Acoustic Wave—a filter used in radio designs
SyncE Synchronous Ethernet
TDD Time Division Duplexing
ToA Time of Arrival
TDoA Time Difference of Arrival
Ubiety ID A UUID assigned to a marked location of interest
UE User Equipment, such as a cell phone
UL Uplink
UTDoA Uplink Time Difference of Arrival
UUID Universally Unique Identifier
UWB Ultra-Wide Band

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-18. (canceled)

19. A method in a WD for disabling a determination of at least one of relative orientation and relative position of the WD, the method comprising:
causing an error in a determination of spatial coordinates of antennas of the WD by configuring the WD to perform at least one of the following:
change a mapping between multiple input multiple output, MIMO, streams and antennas of the WD;
for each antenna of the WD, apply a different code division multiplex, CDM, time offset to a reference signal transmitted by the antenna of the WD;
add inter-symbol clock jitter to a clock signal of the WD;
change a phase center of at least one antenna port of the WD; and
change a polarization of at least one antenna of the WD.

20. The method of claim 19, further comprising configuring the WD to change the mapping between MIMO streams and antennas periodically.

21. The method of claim 19, wherein adding CDM offsets between reference signals transmitted by different antennas of the WD includes adding the CDM offsets periodically.

22. The method of claim 19, wherein adding inter-symbol clock jitter to a clock signal of the WD includes adding a different amount of jitter to a clock signal of the clock of the WD for each antenna of a plurality of antennas of the WD.

23. The method of claim 19, further comprising causing an error in a determination of spatial coordinates of antennas of the WD by configuring the WD to change transmission time offsets periodically.

24. The method of claim 19, further comprising providing a user interface configured to enable a user of the WD to disable the determination of relative orientation of the WD.

25. A WD configured to disable a determination of at least one of relative orientation and relative position of the WD, the WD comprising processing circuitry configured to:
perform at least one of the following:
change a mapping between multiple input multiple output, MIMO, streams and antennas of the WD;
for each antenna of the WD, apply a different code division multiplex, CDM, time offset to a reference signal transmitted by the antenna of the WD;
add inter-symbol clock jitter to a clock signal of the WD;
change a phase center of at least one antenna of the WD; and
change a polarization of at least one antenna of the WD.

26. The WD of claim 25, wherein the processing circuitry is further configured to change the mapping between MIMO streams and antenna speriodically.

27. The WD of claim 25, wherein adding CDM offsets between reference signals transmitted by different antennas of the WD includes adding the CDM offsets periodically.

28. The WD of claim 25, wherein adding inter-symbol clock jitter to a clock signal of the WD includes adding a different amount of jitter to a clock signal of the WD for each antenna of a plurality of antennas of the WD.

29. The WD of claim 25, wherein the processing circuitry is further configured to cause an error in a determination of spatial coordinates of antennas of the WD by configuring the WD to change transmission time offsets periodically.

30. The WD of claim 25, further comprising a user interface configured to enable a user of the WD to disable the determination of relative orientation of the WD.

31. A WD configured to communicate with a network node, the WD comprising:
at least three non-colinear antennas being spaced apart by an amount to enable resolution of spatial coordinates of each of the at least three antennas;
a memory configured to store spatial coordinates for each of the at least three antennas; and
a radio interface configured to transmit an indication of the spatial coordinates to the network node.

32. (canceled)

33. The method of claim 19, further comprising configuring the WD to change a mapping between MIMO streams and antennas of the WD.

34. The method of claim 19, further comprising configuring the WD to apply, for each antenna of the WD, a different CDM time offset to a reference signal transmitted by the antenna of the WD.

35. The method of claim 19, further comprising configuring the WD to add inter-symbol clock jitter to a clock signal of the WD.

36. The method of claim 19, further comprising configuring the WD to change a phase center of at least one antenna port of the WD.

37. The method of claim 19, further comprising configuring the WD to change a polarization of at least one antenna of the WD.

38. The WD of claim 31, wherein the at least three non-co-linear antennas are spaced at least 10 centimeters apart.
